(19) United States
(12) Patent Application Publication
(10) Pub. No.: US 2026/0097356 A1
(43) Pub. Date: Apr. 9, 2026

(54) METHODS FOR USING METAL SILICATES FOR CARBON SEQUESTRATION

(71) Applicant: Knudsen Holdings LLC, Cape Elizabeth, ME (US)

(72) Inventors: Justin Baker RIES, Swampscott, MA (US); Matthew Jordan ODLIN, Freeport, ME (US)

(21) Appl. No.: 19/213,140

(22) Filed: May 20, 2025

Related U.S. Application Data
(63) Continuation of application No. 18/916,047, filed on Oct. 15, 2024, now abandoned.
Application No. 18/916,047 is a continuation of application No. PCT/US2023/066195, filed on Apr. 25, 2023.
(60) Provisional application No. 63/334,356, filed on Apr. 25, 2022.

(51) Int. Cl. B01D 53/14; B01J 20/10

(52) U.S. Cl. CPC B01D 53/1475; B01J 20/10; B01D 2252/10; B01D 2257/504

(57) ABSTRACT

A method includes placing a metal silicate material in a path of a pre-occurring or co-occurring force. The metal silicates have a first carbon capture rate. A change in at least one of a physical property or a chemical property of the metal silicates are allowed over a period of time to cause the metal silicates to have a second carbon capture rate greater than the first carbon capture rate. In some implementations, an amount of CO₂ captured by the metal silicates is quantified through direct measurement, laboratory experiments, modelling, and/or mass balance of the reactants and/or products.

### CROSS-REFERENCE TO RELATED APPLICATIONS

This application is a continuation of U.S. patent application Ser. No. 18/916,047, filed Oct. 15, 2024, entitled “METHODS FOR USING METAL SILICATES FOR CARBON SEQUESTRATION,” which is a continuation of International Patent Application No. PCT/US2023/066195, filed Apr. 25, 2023, entitled “METHODS FOR USING METAL SILICATES FOR CARBON SEQUESTRATION,” which claims priority to, and the benefit of, U.S. Provisional Patent Application No. 63/334,356, filed Apr. 25, 2022, entitled “METHODS FOR USING METAL SILICATES FOR CARBON SEQUESTRATION,” the entire contents of each of which are incorporated by reference herein.

### BACKGROUND

Embodiments described herein relate to methods for increasing carbon capture using metal silicate materials and, in particular, to methods for disintegrating metal silicate materials into smaller particles using pre- or co-occurring forces so as to increase surface area of the metal silicate materials and thereby, increase rate of carbon capture by the metal silicate materials.

Human activity has increased atmospheric CO₂ by approximately 50% (from ˜280 to 420 ppm) over the past 200-300 years due to population growth, combustion of fossil fuels, land use changes, and other industrial processes. These anthropogenic increases in atmospheric CO₂ lead to a variety of environmental and societal problems, including global warming, increased wildfires, increased droughts, increased severity and frequency of storms, sea level rise, melting glaciers, and ocean acidification. One of the great challenges facing humanity in the 21^{st} century is to develop scalable methods for removing CO₂ from the atmosphere in order to stabilize and reduce atmospheric CO₂ in order to limit the environmental and humanitarian damage that is associated with increasing atmospheric CO₂. Thus, there is a need for new methods and materials for accelerated carbon capture.

### SUMMARY

In some implementations, a method includes placing metal silicate material (metal silicates) in a path of a pre-occurring or co-occurring force, the metal silicates having a first carbon capture rate. The method also includes allowing a change in at least one of a physical property or a chemical property of the metal silicates over a period of time to cause the metal silicates to have a second carbon capture rate greater than the first carbon capture rate. In some embodiments, the method may optionally include at least one of pretreating the metal silicates before exposing the metal silicates to the pre-occurring or co-occurring force, or post-treating the metal silicates after exposing the metal silicates to the pre-occurring or co-occurring force. In some embodiments, the method may optionally include quantifying an amount of CO₂ captured by the metal silicates and in some instances, selling carbon offset credits and/or the like associated with the amount of CO₂ captured.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a flowchart of a method for using metal silicates for carbon capture, according to an embodiment.

FIG. 2 illustrates a classification scheme for metal-silicate-bearing igneous rocks, showing increasing concentration of olivine and thus, increasing CO₂ sequestration potential from left to right.

FIG. 3 is a photographic image of an outcropping of flood basalts and FIG. 4 is a photographic image of boulders eroded out of the flood basalts. Light coloration on surface of the outcropping (FIG. 3) and boulders (FIG. 4) is CO₂ sequestered as carbonate minerals through reactions such as those described herein.

FIGS. 5A and 5B are photographic images showing how atmospheric CO₂ is (i) sequestered into spring water of high alkalinity and high concentrations of Mg²⁺ and Ca²⁺ issuing from basaltic bedrock and (ii) precipitated within a surficial CaCO₃ travertine deposit. FIG. 5A shows a spatial relationship between the basalt bedrock (dark rock that finger is pointing to) and the overlying CaCO₃ travertine deposit that sequestered the atmospheric CO₂. FIG. 5B shows an internal layering of the CaCO₃ travertine deposit (touched by fingers) indicating that the atmospheric CO₂ entered and precipitated into actively flowing spring water issuing from the underlying basalt deposit.

FIG. 6 is a photographic image showing sequestration of CO₂ within metal silicate bedrock leading to precipitation of carbonate minerals.

FIG. 7 is a photographic image of boulders eroded out of the flood basalts depicted in FIGS. 3 and 4, showing how mechanical action can abrade precipitated CaCO₃.

FIGS. 8A-8D are graphs illustrating total amount of CO₂ sequestered vs. time for seven types of metal silicates that were reacted in controlled laboratory experiments at 25 degrees Celsius (FIG. 8A and FIG. 8B) and 200 degrees Celsius (FIG. 8C and FIG. 8D), and at a low partial pressure of carbon dioxide (pCO₂) condition (FIG. 8A and FIG. 8C) and a high pCO₂ condition (FIG. 8B and FIG. 8D).

FIGS. 9A-9D are graphs illustrating amounts of solid MgCO₃ produced vs. time for seven types of metal silicates that were reacted in controlled laboratory experiments at 25 degrees Celsius (FIGS. 9A and 9B) and 200 degrees Celsius (FIGS. 9C and 9D), and at low pCO₂ (FIGS. 9A and 9C) and high pCO₂ (FIGS. 9B and 9D) conditions.

FIGS. 10A-10D are graphs illustrating total alkalinity of solution vs. time for seven types of metal silicates that were reacted in controlled laboratory experiments at 25 degrees Celsius (FIG. 10A and FIG. 10B) and 200 degrees Celsius (FIG. 10C and FIG. 10D), and at low pCO₂ (FIG. 10A and FIG. 10C) and high pCO₂ (FIG. 10B and FIG. 10D) conditions.

FIGS. 11A-11D are graphs illustrating amounts of total dissolved solids in solution vs. time for seven types of metal silicates that were reacted in controlled laboratory experiments at 25 degrees Celsius (FIG. 11A and FIG. 11B) and 200 degrees Celsius (FIG. 11C and FIG. 11D), and at low pCO₂ (FIG. 11A and FIG. 11C) and high pCO₂ (FIG. 11B and FIG. 11D) conditions.

FIGS. 12A-12D are graphs illustrating a pH of a solution vs. time for seven types of metal silicates that were reacted in controlled laboratory experiments at 25 degrees Celsius (FIG. 12A and FIG. 12B) and 200 degrees Celsius (FIG. 12C and FIG. 12D), and at low pCO₂ (FIG. 12A and FIG. 12C) and high pCO₂ (FIG. 12B and FIG. 12D) conditions.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate to methods for increasing carbon capture capacity and/or ability of metal silicate minerals. In some implementations, embodiments described herein may include methods for increasing a reactivity of metal silicate minerals, which in turn, may increase the carbon capture capacity and/or ability of the minerals. Metal silicate minerals (generally referred to herein as “metal silicates”) are globally abundant and include 15% of the Earth's continental crust (which covers 30% of earth's surface) and nearly 100% of oceanic crust (which covers 70% of Earth's surface). Metal silicates include igneous rocks, including those classified as felsic (e.g., granite, rhyolite), intermediate (e.g., diorite, andesite), mafic (e.g., gabbro, basalt), and ultramafic (e.g., peridotite, komatiite). Metal silicates are known absorbers of carbon dioxide. For example, metal silicates can react with water and/or seawater to generate alkalinity and divalent cations (e.g., Ca²⁺, Mg²⁺, Fe²⁺, etc.) and sequester carbon dioxide (CO₂) in the form of aqueous bicarbonate ions (HCO₃—) and carbonate ions (CO₃²⁻), and solid carbonate minerals (CaCO₃, MgCO₃, CaMgCO₃, FeCO₃, etc.) through a process known as chemical weathering. One of the minerals involved in this reaction is olivine, which is a magnesium-iron silicate with the chemical formula (Mg²⁺, Fe²⁺)₂SiO₄. The olivine content, and thus a CO₂ sequestration potential of metal silicates and the igneous rocks that they form increases towards the ultramafic end of the igneous classification spectrum (e.g., olivine content and CO₂ sequestration potential increasing in the following order: felsic, intermediate, mafic, ultramafic). Some examples of idealized reactions illustrating CO₂ sequestration via carbonation of metal silicates are provided below:

Mg₂SiO₄+2CO₂+2H₂O→2MgCO₃+H₄SiO₄ (carbonation of Magnesium (Mg) silicate)

CaSiO₃+CO₂+2H₂O→CaCO₃+H₄SiO₄ (carbonation of Calcium (Ca) silicate)

Fe₂SiO₄+2CO₂+2H₂O→2FeCO₃+H₄SiO₄ (carbonation of Iron (Fe) silicate)

Mg₃Si₂O₅(OH)₄+3CO₂+2H₂O→3MgCO₃+2H₄SiO₄ (carbonation of hydrated Mg silicate)

Naₓ(Ca,Mg,Fe)_{y}Si₃AlO₈+(x+2y+3)H⁺+(4+y)H₂O+yCO₂→xNa++y(Ca,Mg,Fe)CO₃+3H₄SiO₄+2y(H⁺) (carbonation of plagioclase group silicates)

The idealized reactions above each summarize a series of reactions, which can be described by the following reaction scheme, for example, described with respect to the carbonation of Mg₂SiO4:

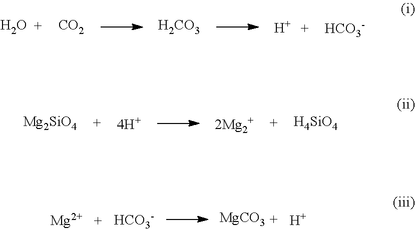

Reaction (i) describes the dissolution of atmospheric CO₂ in water, which forms carbonic acid (H₂CO₃) that dissociates into free hydrogen (H⁺) and bicarbonate (HCO₃⁻) ions. Reaction (ii) describes dissolution of the silicate mineral, which generates free Mg²⁺ ions and aqueous silicic acid (H₄SiO₄). Reaction (iii) describes the reaction of free Mg²⁺ ions with free HCO₃⁻ ions, which effectively mineralizes sequestered atmospheric CO₂ as magnesite (MgCO₃) and releases free H⁺ ions.

One known method for using metal silicates for carbon sequestration includes mining from natural deposits and then grinding and pulverizing to the material into very small sizes (e.g., a gain size of about 100 microns to 300 microns) in order to increase their reactive surface area, thereby increasing their capacity to react with and sequester atmospheric CO₂. However, this process requires extensive grinding and pulverizing of metal silicates down to the 100 micron to 300 micron grain size in order to increase their reactive surface area and increase their rate of CO₂ sequestration to a level that is capable of contributing to the stabilization or reduction of atmospheric CO₂. Moreover, the hardness and density of metal silicates make grinding/pulverizing expensive, both from an energetic standpoint and from a CO₂ emissions standpoint, which reduces the value of the sequestered CO₂ on both the top line (i.e., after reducing revenue by cost of energy) and bottom line (after reducing revenue by cost of emitted CO₂), reducing the economic viability of this method for sequestering CO₂.

Rates and magnitudes of CO₂ sequestration via reaction with metal silicates can also be increased by heating the reactants, but this too is expensive from both energetic and CO₂ emission standpoints, reducing the economic viability of this method for sequestering CO₂. The cost of sequestering CO₂ via enhanced weathering of ground, pulverized, and/or heated metal silicates typically exceeds the value of the CO₂ credit that is generated from that reaction, rendering the process economically unviable as a method for sequestering atmospheric CO₂. Furthermore, the products of the reaction between the metal silicates, CO₂, and water (typically clay and solid carbonate minerals) are waste products that generally are disposed of.

Another conventional method for using metal silicates for carbon sequestration includes injecting pure CO₂ streams (e.g., from fossil fuel-fired power plants or other industrial sources) into metal silicate bedrock, where the injected CO₂ reacts with divalent cations (Ca, Mg, Fe) and alkalinity (CO₃²⁻, HCO₃⁻, OH⁻) dissolved in the groundwater within the bedrock to be stably sequestered in the form of a solid carbonate minerals (e.g., CaCO₃, MgCO₃, FeCO₃). However, conversion of gaseous or liquified CO₂ to a solid carbonate mineral after it is injected into metal silicate bedrock can increase the volume of the local bedrock by up to 30%, which can expand and uplift the bedrock. This can cause hills to form rapidly above the injection sites, which can modify the natural landscape and built environment, lead to an increase in the frequency of local earthquakes, and pollute the local groundwater, thus creating environmental, geological, and public health hazards. Moreover, sites for injecting CO₂ into metal silicate bedrock are limited and transport of pure CO₂ streams to injection sites can require expensive and unsightly infrastructure and/or delivery methods. The capacity for an injection site to store pure CO₂ streams is also limited. Once the capacity of an injection site for storing CO₂ is exceeded, a new injection site is located and drilled, and the infrastructure for delivering the pure CO₂ stream is relocated and rebuilt. In general, there is a 1-10-year lag between when the CO₂ is injected into the metal silicate bedrock and when that CO₂ is stably sequestered as a solid carbonate mineral, during which time the injected CO₂ can rise back to the surface layer of the metal silicate bedrock and re-enter the atmosphere.

For at least the reasons stated above, such known methods of using metal silicates for carbon sequestration are not or may not be suitable for large-scale, atmospherically significant carbon sequestration. Accordingly, embodiments described herein relate to low-energy methods for using and/or facilitating the use of globally abundant metal silicates, such as those comprising igneous rocks, to sequester CO₂ from the atmosphere.

In some implementations, embodiments described herein can include methods for disposing or spreading metal silicates in the path of forces, activities, objects, and chemicals that will spread, grind, pulverize, turn, abrade, heat, and/or chemically react with these metal silicates, thereby increasing their reactive surface area and accelerating the rate at which they sequester atmospheric CO₂. Embodiments and/or methods described herein can also include pre-treating metal silicates with heat, chemicals (acids, CO₂, salts), and/or moisture in order to further accelerate the rate that the distributed metal silicates react with and sequester atmospheric CO₂. Any of the embodiments and/or methods described herein can provide for and/or can include quantifying and/or estimating the amount of atmospheric CO₂ that is sequestered via reaction with the distributed and potentially pre-treated metal silicates. In some instances, credits and/or the like associated with the amount of sequestered atmospheric CO₂ may be valued and sold, for example, as a carbon offset credit and/or the like.

For example, in some implementations, a method includes placing metal silicates-having a first carbon capture rate-in a path of a pre-occurring or co-occurring force. The method also includes allowing a change in at least one of a physical property or a chemical property of the metal silicates over a period of time to cause the metal silicates to have a second carbon capture rate greater than the first carbon capture rate.

In some implementations, a method includes placing metal silicates-having a first carbon capture rate-in a path of a pre-occurring or co-occurring force. The method also includes allowing a change of a particle size of the metal silicates over a period of time as a result of the pre-occurring or co-occurring force such that the metal silicates have a second carbon capture rate greater than the first carbon capture rate.

In some implementations, a method includes placing metal silicates-having a first reactivity associated with carbon capture-in a path of a pre-occurring or co-occurring force. The pre-occurring or co-occurring force is operable to change at least one of a physical property or a chemical property of the metal silicate. The method also includes allowing a change in the metal silicates over a period of time as a result of the pre-occurring or co-occurring force such that the metal silicates have a second reactivity associated with carbon capture greater than the first reactivity.

In some implementations, any of the methods described herein (or portions or combinations thereof) may optionally include selecting the metal silicates from at least one of an intermediate igneous geological formation, mafic igneous geological formation, and/or an ultramafic igneous geological formation. In some implementations, any of the methods described herein (or portions or combinations thereof) may optionally include at least one of pretreating the metal silicates before exposing the metal silicates to the pre-occurring or co-occurring force, or post-treating the metal silicates after exposing the metal silicates to the pre-occurring or co-occurring force. In some embodiments, any of the methods described herein (or portions or combinations thereof) may optionally include quantifying an amount of CO₂ captured by the metal silicate and in some instances, selling carbon offset credits and/or the like associated with the amount of CO₂ captured.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

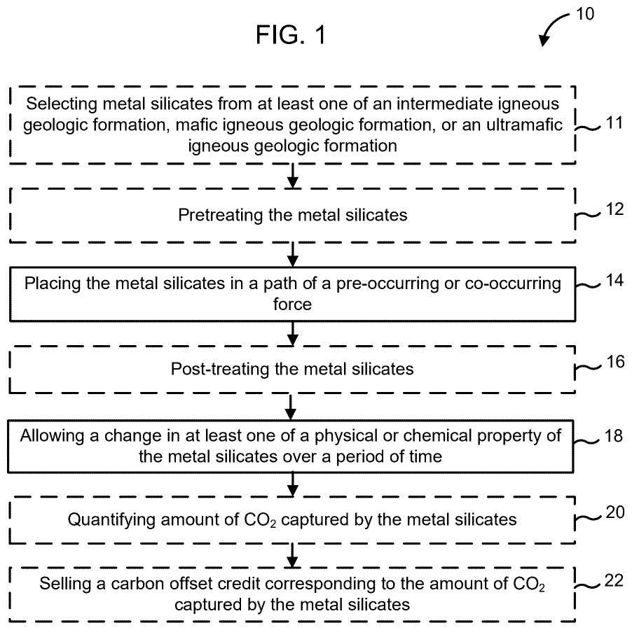

FIG. 1 is schematic flow chart of a method 10 for using metal silicates for providing carbon capture or carbon sequestration, according to an embodiment. In some embodiments, the method 10 optionally includes selecting metal silicates from at least one of an intermediate igneous geologic formation, mafic igneous geologic formation, or an ultramafic igneous geologic formation, at 11. Selecting the metal silicates can be based on any suitable factors and/or characteristics such as, for example, carbon sequestering rate, cost, weight, and/or other criteria.

The method 10 includes disposing the metal silicates in the path of a pre-occurring or co-occurring force, at 14. For example, the method 10 may including distributing, spreading, layering, or co-locating metal silicates across a range of pathways that will subject them to the activities, forces, objects, and/or chemicals needed to spread, grind, pulverize, turn, abrade, heat, and/or chemically react them in order to reduce their size and increase their surface area, thereby increasing their capacity for sequestering CO₂. These pathways may include, but are not limited to, developed public roadways and highways, undeveloped public and private roadways, parking lots, sidewalks, airport runways, rail beds, rooftops, snowmobile trails, recreational trails and paths (hiking, biking, horse, x-country ski trails), alpine (downhill) ski slopes, riverbeds, glacial pathways and outwash plains, floating substrates in bodies of water, islands and platforms in bodies of water, and the active margins of lakes, seas and oceans. The pre-occurring or co-occurring force(s), as referred to herein, is/are force(s) that occur or may occur regardless of whether the metal silicates are placed in its/their path. In some embodiments, the pre-occurring or co-occurring force(s) is/are force(s) that occur without a net input of energy and/or expense from the perspective of an entity, user, etc. that has placed the metal silicates in the path of such forces. For example, a vehicle traveling along a road exerts a force (a pre-occurring or co-occurring force) on the road as it travels independent of the presence of the metal silicates described herein. As such, distributing metal silicates on the road and in the path of the vehicle places the metal silicates in and/or along the path of the pre-occurring or co-occurring force.

The method 10 also includes allowing a change in physical or chemical property of the metal silicates over a period of time, at 18. For example, in some implementations, disposing or spreading the metal silicates in the path of the pre-occurring or co-occurring force may allow and/or provide a vehicle for a change in a physical parameter of the metal silicates via crushing, breaking, grinding, turning, abrading, or otherwise reducing a size of the metal silicates over a period of time. The change in physical parameter generally increases the surface area of the metal silicates, which in turn, can provide an increase in a carbon capture rate associated with the metal silicates.

Example methods associated with each of these pathways are described in further detail below. While various examples and/or methods are described herein, it should be appreciated that various other methods for using pre-occurring and/or co-occurring forces for reducing size and increasing surface area of metal silicates are envisioned and are intended to be within the scope of the present disclosure.

(i) Developed public roadways and highways: Distribution, spreading, or otherwise disposing of metal silicates on developed public roadways and highways can allow and/or can provide a process for the metal silicates to be ground and pulverized by the mechanical action (e.g., grinding, pulverizing, running over, smashing, pounding, exposing to friction forces, etc.) of tires, snow chains, graders, and snowplows, which will increase the ratio of the reactive surface area of the metal silicate grains relative to their volumes, thereby increasing their capacity to react with and sequester CO₂. Disposing or distribution of metal silicates on public roadways and highways may also increase their reactive surface area by spreading them in a thin layer over a broad area, thereby increasing the proportion of grains that are in direct contact with atmospheric CO₂ and increasing their capacity to sequester CO₂. Distribution of metal silicates on public roadways and highways may also agitate and turn the metal silicate grains into a higher number of finer grains, further increasing the proportion of grains in direct contact with atmospheric CO₂ and increasing their capacity to sequester CO₂. The mechanical action of tires, snow chains, graders, and snowplows may also abrade precipitated CaCO₃ (derived from the sequestered CO₂) off of the surfaces of the metal silicate grains, thereby re-exposing and reactivating old surfaces and/or unreacted new surfaces for reaction with and sequestration of CO₂.

The mechanical action of tires, snow chains, graders, and snowplows may also generate friction with the distributed metal silicates, which will increase their temperatures, thereby increasing their rate of reaction and, therefore, their capacity to sequester atmospheric CO₂. The temperature and thus capacity of metal silicates to sequester CO₂ may also be increased by providing heating elements located on or within roadways and highways that are used for de-icing. Distribution of metal silicates on public roadways and highways may also cause additional CO₂, such as from the exhaust of vehicles traveling on those roads, to react with the metal silicates, thereby increasing their rate of and capacity for sequestering CO₂. Distribution of metal silicates on public roadways and highways may also cause them to react with chemicals that are already (or not yet) deployed, or in the process of being deployed, to increase traction on the traveled surfaces, such as road salts (e.g., MgCl₂, CaCl₂), NaCl, (Mg,Ca)Cl₂) or alkaline or acidic chemicals, which may accelerate the dissolution of the metal silicates and/or mineralization of the sequestered CO₂ as carbonate minerals. Distribution of metal silicates on public roadways and highways may also generate additional byproducts of the weathering reactions (silicic acid, clays, carbonate minerals), which may increase vehicular traction on the traveled surfaces, especially when the travelled surfaces are subject to ice, snow, rain, and other conditions that decrease the friction of those surfaces. In this manner, distributing metal silicates on developed public roadways and highways can provide and/or can result in multiple modes of grinding, pulverizing, treating, weathering, etc. the metal silicates, which in turn, can increase a capacity or potential of the metal silicates to sequester CO₂.

(ii) Undeveloped public and private roadways: Distribution, spreading, or otherwise disposing of metal silicates on undeveloped public and private roadways may increase the capacity for metal silicates to sequester CO₂ through the same methods, as well as yield the same benefits with respect to traffic, as described with respect to distribution of metal silicates on developed public roadways and highways. In this manner, distributing metal silicates on undeveloped public and private roadways can provide and/or can result in multiple modes of grinding, pulverizing, treating, weathering, etc. the metal silicates, which in turn, can increase a capacity or potential of the metal silicates to sequester CO₂.

(iii) Parking lots: Distribution, spreading, or otherwise disposing of metal silicates on parking lots may increase the capacity for metal silicates to sequester CO₂ through the same mechanisms, as well as yield the same benefits with respect to traffic, as described with respect to distribution of metal silicates on developed public roadways and highways. In this manner, distributing metal silicates on parking lots can provide and/or can result in multiple modes of grinding, pulverizing, treating, weathering, etc. the metal silicates, which in turn, can increase a capacity or potential of the metal silicates to sequester CO₂.

(iv) Sidewalks: Distribution, spreading, or otherwise disposing of metal silicates on sidewalks may increase the capacity for metal silicates to sequester CO₂ through the same mechanisms, as well as yield the same benefits with respect to traffic, as described with respect to distribution of metal silicates on developed public roadways and highways. In such implementations, the term “traffic” is meant to include vehicular traffic (e.g., certain vehicles such as bicycles, tricycles, scooters, electric scooters, mopeds, etc.) as well as human or animal traffic (e.g., “foot traffic”). In this manner, distributing metal silicates on sidewalks can provide and/or can result in multiple modes of grinding, pulverizing, treating, weathering, etc. the metal silicates, which in turn, can increase a capacity or potential of the metal silicates to sequester CO₂.

(iv) Airport runways/surfaces: Distribution, spreading, or otherwise disposing of metal silicates on airport runways may increase the capacity for metal silicates to sequester CO₂ through the same mechanisms, as well as yield the same benefits with respect to vehicular traffic, as described with respect to distribution of metal silicates on developed public roadways and highway, where traffic can include both ground vehicles as well as aircraft travelling on the ground (e.g., during transport, taxiing, prior to take-off, after landing, etc.). In this manner, distributing metal silicates on airport runways can provide and/or can result in multiple modes of grinding, pulverizing, treating, weathering, etc. the metal silicates, which in turn, can increase a capacity or potential of the metal silicates to sequester CO₂.

(v) Rail beds: Distribution, spreading, or otherwise disposing of metal silicates on rail beds may increase their reactive surface area by spreading them in a thin layer over a broad area, thereby increasing the proportion of grains that are in direct contact with atmospheric CO₂ and increasing their capacity to sequester CO₂. Distribution of metal silicates on railbeds may also cause additional CO₂, such as from the exhaust of coal or oil-powered trains, to react with the metal silicates, thereby increasing their rate of and capacity for sequestering CO₂. The friction between the train wheels and rails may also generate heat, which will increase the temperature of the metal silicates, thereby increasing their rate of reaction with, and capacity to sequester, atmospheric CO₂. The temperature and thus capacity of metal silicates distributed on railbeds to sequester CO₂ may also be increased by heating elements located on or within the railbeds that are used for de-icing. Distribution of metal silicates on railbeds may also cause them to react with chemicals that are already (or not already) deployed and/or being deployed to clean and/or de-ice the railways, such as road salts (e.g., MgCl₂, CaCl₂, NaCl, (Mg,Ca)Cl₂) or other alkaline or acidic chemicals, which may accelerate the dissolution of the metal silicates and/or mineralization of the sequestered CO₂ as carbonate minerals. Distribution of metal silicates on railbeds may also generate additional byproducts of the weathering reactions (silicic acid, clays, carbonate minerals), that may increase the stability of the railbed by, for example, cementing the sediment and gravel within the railbed and reducing the effects of erosion. In this manner, distributing metal silicates on rail beds can provide and/or can result in multiple modes of grinding, pulverizing, treating, weathering, etc. the metal silicates, which in turn, can increase a capacity or potential of the metal silicates to sequester CO₂.

(vi) Rooftops: Distribution, spreading, or otherwise disposing of metal silicates on rooftops may increase their reactive surface area by spreading them in a thin layer over a broad area, thereby increasing the proportion of grains that are in direct contact with atmospheric CO₂ and increasing their capacity to sequester CO₂. Distribution of metal silicates on rooftops may also cause additional CO₂, such as from the exhaust of oil, gas, wood, and/or coal-fired heating appliances, fireplaces, or stoves within the house, to react with the metal silicates, thereby increasing their rate of and capacity for sequestering CO₂. Such additional CO₂ may be intentionally or unintentionally diverted to the metal silicates. Distribution of metal silicates on rooftops may also cause them to react with chemicals that are already (or not already) deployed and/or being deployed to de-ice the roof, such as road salts (e.g., MgCl₂, CaCl₂), NaCl, (Mg,Ca)Cl₂) or other alkaline or acidic chemicals, which may accelerate the dissolution of the metal silicates and/or mineralization of the sequestered CO₂ as carbonate minerals.

Distribution, spreading, or otherwise disposing of metal silicates on rooftops may also increase their temperatures, such as from heat tape, solar radiation, leakage from the home interior, and/or other sources, thereby increasing their rate of reaction with, and capacity to sequester atmospheric CO₂. Distribution, spreading, or otherwise disposing of metal silicates on rooftops may also generate additional byproducts of the weathering reactions (e.g., silicic acid, clays, carbonate minerals), that may increase the stability of the rooftop by, for example, cementing the disaggregated constituents of the rooftop and reducing the effects of weather and/or erosion. In this manner, distributing metal silicates on rooftops can provide and/or can result in multiple modes of treating, weathering, and/or otherwise increasing an exposure of the metal silicates, which in turn, can increase a capacity or potential of the metal silicates to sequester CO₂.

(vii) Snowmobile trails: Distribution, spreading, or otherwise disposing of metal silicates on snowmobile trails may increase the capacity for metal silicates to sequester CO₂ through the same mechanisms, as well as yield the same benefits with respect to traffic, as described with respect to distribution of metal silicates on developed public roadways and highways, where the term “traffic” can include snowmobile traffic. In this manner, distributing metal silicates on snowmobile trails can provide and/or can result in multiple modes of grinding, pulverizing, treating, weathering, etc. the metal silicates, which in turn, can increase a capacity or potential of the metal silicates to sequester CO₂.

(viii) Recreational and/or sport trails and paths such as hiking, biking, horse, cross-country skiing, marathons, track and field, etc.: Distribution, spreading, or otherwise disposing of metal silicates on recreational trails and paths may cause the metal silicates to be ground and pulverized by the mechanical action of tires, graders, groomers, and snowplows, which will increase the ratio of the reactive surface area of the metal silicate grains relative to their volumes, thereby increasing their capacity to react with and sequester CO₂. Distribution, spreading, or otherwise disposing of metal silicates on recreational trails and paths may increase their reactive surface area by spreading them in a thin layer over a broad area, thereby increasing the proportion of grains that are in direct contact with atmospheric CO₂ and increasing their capacity to sequester CO₂.

Distribution, spreading, or otherwise disposing of metal silicates on recreational trails and paths may also cause them to react with chemicals that are already (or not already) deployed and/or being deployed to de-ice the trails and paths, such as road salts (e.g., MgCl₂, CaCl₂, NaCl, (Mg,Ca)Cl₂) or other alkaline or acidic chemicals, which may accelerate the dissolution of the metal silicates and/or mineralization of the sequestered CO₂ as carbonate minerals. Distribution of metal silicates on recreational trails and paths may also increase their temperatures, potentially due to heat sources on or within the trails and paths used for de-icing, thereby increasing their rate of reaction with, and capacity to sequester, atmospheric CO₂. Distribution, spreading, or otherwise disposing of metal silicates on recreational trails and paths may also generate additional byproducts of the weathering reactions (e.g., silicic acid, clays, carbonate minerals), that may increase the stability of the trails and paths by, for example, cementing the sediments with the trails and paths together and reducing the effects of erosion. In this manner, distributing metal silicates on recreational and/or sport trails, tracks, etc. can provide and/or can result in multiple modes of grinding, pulverizing, treating, weathering, etc. the metal silicates, which in turn, can increase a capacity or potential of the metal silicates to sequester CO₂.

(ix) Alpine (downhill) ski slopes: Distribution, spreading, or otherwise disposing of metal silicates on alpine ski slopes may cause the metal silicates to be ground and pulverized by the mechanical action of skis, snowmobiles, graders, snowplows, and groomers, which may increase the ratio of the reactive surface area of the metal silicate grains relative to their volumes, thereby increasing their capacity to react with and sequester CO₂. Distribution of metal silicates on alpine ski slopes may increase their reactive surface area by spreading them in a thin layer over a broad area, thereby increasing the proportion of grains that are in direct contact with atmospheric CO₂, thereby increasing their capacity to sequester CO₂. Distribution of metal silicates on alpine ski slopes may also generate additional byproducts of the weathering reactions (e.g., silicic acid, clays, carbonate minerals), that may increase the stability of the ski slopes by, for example, cementing together the sediments on the ski slope and reducing the effects of erosion. In this manner, distributing metal silicates on alpine (downhill) ski slopes can provide and/or can result in multiple modes of grinding, pulverizing, treating, weathering, etc. the metal silicates, which in turn, can increase a capacity or potential of the metal silicates to sequester CO₂.

(x) Riverbeds: Distribution, spreading, or otherwise disposing of metal silicates in riverbeds may cause the metal silicates to be ground and pulverized by the mechanical action of water, ice, rocks, sediment, and other debris being transported down the rivers, which may increase the ratio of the reactive surface area of the metal silicate grains relative to their volumes, thereby increasing their capacity to react with and sequester CO₂. Distribution of metal silicates in riverbeds may also increase their reactive surface area by spreading them in a thin layer over a broad area, thereby increasing the proportion of grains that are in direct contact with atmospheric CO₂, thereby increasing their capacity to sequester CO₂. Distribution of metal silicates in riverbeds may also agitate and turn the metal silicate grains, further increasing the proportion of grains in direct contact with atmospheric CO₂ increasing their capacity to sequester CO₂. The mechanical action of flowing water, ice, rocks, sediment, and other debris along the river may also abrade precipitated CaCO₃ (e.g., derived from the sequestered CO₂) off of the surfaces of the metal silicate grains, thereby re-exposing and reactivating their old and/or new unreacted surfaces for reaction with and sequestration of additional CO₂. Distribution of metal silicates in riverbeds may also generate additional byproducts of the weathering reactions (e.g., silicic acid, clays, carbonate minerals), that may increase the stability of the riverbed and/or its banks by, for example, cementing together the sediments in the river system and reducing the effects of erosion and/or sea level rise. In this manner, distributing metal silicates on or in riverbeds can provide and/or can result in multiple modes of grinding, pulverizing, treating, weathering, etc. the metal silicates, which in turn, can increase a capacity or potential of the metal silicates to sequester CO₂.

(xi) Glacial pathways and outwash plains: Distribution, spreading, or otherwise disposing of metal silicates in the pathways and outwash plains of active glaciers may cause the metal silicates to be ground and pulverized by the mechanical action of water, ice, rocks, sediment, and/or other debris being transported by the glaciers, which may increase the ratio of the reactive surface area of the metal silicate grains relative to their volumes, thereby increasing their capacity to react with and sequester CO₂. Distribution of metal silicates in the pathways and outwash plains of active glaciers may also increase their reactive surface area by spreading them in a thin layer over a broad area, thereby increasing the proportion of grains that are in direct contact with atmospheric CO₂ and increasing their capacity to sequester CO₂. Distribution of metal silicates in the pathways and outwash plains of active glaciers will also agitate and turn the metal silicate grains, further increasing the proportion of grains in direct contact with atmospheric CO₂ increasing their capacity to sequester CO₂. The mechanical action of the water, ice, rocks, sediment, and other debris being transported by the glaciers may also abrade precipitated CaCO₃ (derived from the sequestered CO₂) from the surfaces of the metal silicate grains, thereby re-exposing and reactivating their old and/or new unreacted surfaces for reaction with and sequestration of additional CO₂. Distribution, spreading, or otherwise disposing of metal silicates in the pathways and outwash plains of active glaciers may also generate additional byproducts of the weathering reactions (e.g., silicic acid, clays, carbonate minerals), that may increase the stability of the glacier, its outwash plain, and the periglacial environment by, for example, cementing together the sediments in those systems and reducing the effects of erosion and/or sea level rise. In this manner, distributing metal silicates on or in glacial pathways and outwash plains can provide and/or can result in multiple modes of grinding, pulverizing, treating, weathering, etc. the metal silicates, which in turn, can increase a capacity or potential of the metal silicates to sequester CO₂.

(xii) Floating substrates in bodies of water: Distributing, spreading, and/or otherwise disposing metal silicates within and/or on the surface of bodies of water may cause the metal silicates to be ground and pulverized by the mechanical action of water, ice, rocks, sediment, and other debris being transported by currents or wave action of the body of water, and potentially by interaction with the shoreline and sea bed, lake bed, or river bed, which may increase the ratio of the reactive surface area of the metal silicate grains relative to their volumes, thereby increasing their capacity to react with and sequester CO₂. Similarly, distributing, spreading, and/or otherwise disposing metal silicates on or from floating substrates disposed in the bodies of water, including manufactured buoys or other floatation devices, as well as naturally occurring floating substrates, including those that may or may not sink and/or disaggregate, may cause the metal silicates to be ground and pulverized in response to the same actions/interactions. Distribution of metal silicates within, on the surface of, or from floating natural and/or artificial substrates, may also increase their reactive surface area by spreading them in a thin layer over a broad area and/or by agitating and/or turning the metal silicate grains, thereby increasing the proportion of grains that are in direct contact with atmospheric or dissolved CO₂, thereby increasing their capacity to sequester CO₂. Transport or sinking of the metal silicates to waters of differing chemistries and temperatures, such as those that are more acidic, warmer, and/or higher in CO₂, may also increase the rate that the metal silicates react with and sequester CO₂.

In some implementations, for example, the mechanical action of the water, ice, rocks, sediment, and other debris being transported by currents and/or wave action of the bodies of water, as well as interactions with shorelines and sea beds, lake beds, and river beds, may abrade precipitated CaCO₃ (e.g., derived from the sequestered CO₂) from the surfaces of the metal silicate grains, thereby re-exposing and reactivating their old and/or new unreacted surfaces for reaction with, and sequestration of, additional CO₂. Distribution of metal silicates within, on the surface of, or from floating substrates may also generate additional byproducts of the weathering reactions (e.g., silicic acid, clays, carbonate minerals), that may increase or decrease the stability of these natural or artificial floating substrates by, for example, cementing together the sediments in the agglomerated floating substrates and reducing the effects of erosion and/or sea level rise, or by reducing the cohesion of the agglomerated floating substrates. In this manner, distributing metal silicates within, on the surface of, or from floating substrates can provide and/or can result in multiple modes of grinding, pulverizing, treating, weathering, etc. the metal silicates, which, in turn, can increase a capacity or potential of the metal silicates to sequester CO₂.

(xiii) Islands and platforms in water bodies: Distribution, spreading, or otherwise disposing of metal silicates within, on the surface of, or from surface or subsurface islands, banks, and/or platforms, may cause the metal silicates to be ground and pulverized by the mechanical action of water, ice, rocks, sediment, and other debris being transported by currents or wave action of the body of water, and potentially by interaction with marine and terrestrial vehicles and traffic that pass over the metal silicates which may increase the ratio of the reactive surface area of the metal silicate grains relative to their volumes, thereby increasing their capacity to react with and sequester CO₂. Such surface and/or subsurface islands can include, for example, both natural and artificial islands (including islands of all sizes and artificial islands such as those being formed and/or expanded throughout the world, e.g. South China Sea, Persian Sea, Persian Gulf, Netherlands/North Sea, Maldives, etc.). Such surface or subsurface platforms can include, for example, oil drilling platforms, lighthouses, windmills (or wind-power turbine structures), and/or the like.

Distribution of metal silicates within, on the surface of, or from islands, banks, and platforms may also increase their reactive surface area by spreading them in a thin layer over a broad area and/or by agitating and/or turning the metal silicate grains, thereby increasing the proportion of grains that are in direct contact with atmospheric and/or dissolved CO₂, thereby increasing their capacity to sequester CO₂. Transport or sinking of the metal silicates to waters of differing chemistries and temperatures as they are deployed within, on the surface of, or from islands, banks, and platforms, such as waters that are more acidic, warmer, and/or higher in CO₂, may also increase the rate that the metal silicates react with and sequester CO₂.

In some implementations, for example, the mechanical action of the water, ice, rocks, sediment, and other debris being transported by currents and/or wave action of the water bodies may abrade precipitated CaCO₃ (e.g., derived from the sequestered CO₂) from the surfaces of the metal silicate grains, thereby re-exposing and reactivating their old and/or new unreacted surfaces for reaction with and sequestration of additional CO₂. Distribution of metal silicates within, on the surface of, or from islands, banks, and platforms may also generate additional byproducts of the weathering reactions (e.g., silicic acid, clays, carbonate minerals), that may increase the stability of these natural or artificial islands, banks, and platforms by, for example, cementing together the sediments, gravel, and/or boulders deployed as anchorage, rip-rap, and/or foundation in those systems, which may reduce the effects of erosion, increased storm activity, and/or sea level rise. In this manner, distributing metal silicates within, on the surface of, or from islands, banks, and platforms can provide and/or can result in multiple modes of grinding, pulverizing, treating, weathering, etc. the metal silicates, which in turn, can increase a capacity or potential of the metal silicates to sequester CO₂.

(xiv) Active margins of lakes, seas, and oceans: Distribution, spreading, or otherwise disposing of metal silicates along the active margins of lakes, seas and oceans may cause the metal silicates to be ground and pulverized by the mechanical action of water, ice, rocks, sediment, and other debris being transported by the longshore drift and/or wave action of the water bodies, which will increase the ratio of the reactive surface area of the metal silicate grains relative to their volumes, thereby increasing their capacity to react with and sequester CO₂. Distribution of metal silicates along the margins of lakes, seas and oceans may also increase their reactive surface area by spreading them in a thin layer over a broad area, thereby increasing the proportion of grains that are in direct contact with atmospheric CO₂, thereby increasing their capacity to sequester CO₂.

Distribution, spreading, or otherwise disposing of metal silicates along the margins of lakes, seas and oceans may also agitate and turn the metal silicate grains, further increasing the proportion of grains in direct contact with atmospheric CO₂ increasing their capacity to sequester CO₂. The mechanical action of the water, ice, rocks, sediment, and other debris being transported by the longshore drift and/or wave action of the water bodies may also abrade precipitated CaCO₃ (e.g., derived from the sequestered CO₂) from the surfaces of the metal silicate grains, thereby re-exposing and reactivating their old and/or new unreacted surfaces for reaction with and sequestration of additional CO₂. Distribution of metal silicates along the active margins of lakes, seas and oceans may also generate additional byproducts of the weathering reactions (e.g., silicic acid, clays, carbonate minerals), that may increase the stability of the active margins of lakes and oceans by, for example, cementing together the sediments in those systems and reducing the effects of erosion and/or sea level rise. In this manner, distributing metal silicates on or in the active margins of lakes, seas, and oceans can provide and/or can result in multiple modes of grinding, pulverizing, treating, weathering, etc. the metal silicates, which in turn, can increase a capacity or potential of the metal silicates to sequester CO₂.

Referring back to FIG. 1, in some embodiments, the method 10 may optionally include pretreating the metal silicates before exposing the metal silicates to the pre-occurring or co-occurring force, at 12. Additionally, or alternatively, the method 10 may optionally include post-treating the metal silicates after exposing the metal silicate to the pre-occurring or co-occurring force, at 16. Expanding further, the metal silicates may be pre-treated and/or post-treated with mechanical grinding, heat, chemicals (e.g., acids, bases, CO₂, salts, etc.), and moisture in order to further accelerate the rate that the distributed metal silicates react with and sequester atmospheric CO₂. This pre-treatment could be accomplished within the facilities where the metal silicates are stored prior to distribution and/or within the storage compartments of vehicles that are responsible for distributing the metal silicates. Treatments could also be applied after the metal silicates have been distributed by ground vehicles (e.g., trucks, trains, etc.), marine vessels (boats, buoys, barges), and/or aerial vehicles (e.g., planes, drones, helicopters, etc.).

As discussed previously, mechanical grinding may increase the capacity and/or reactivity of the metal silicates to sequester CO₂ by increasing the reactive surface area of the metal silicate grains. The application of heat may increase the capacity and/or reactivity of metal silicates to sequester CO₂ by accelerating the kinetics of the reaction between the metal silicates, water, atmosphere, and CO₂. The application of chemicals, such as acids, bases, CO₂, and salts, may increase the capacity and/or reactivity of metal silicates to sequester CO₂ by accelerating the kinetics of the reaction between the metal silicates, water, atmosphere, and CO₂ by, for example, increasing the rate and/or magnitude of the dissolution (hydrolysis) of the metal silicates, and/or by increasing the rate and/or magnitude of the precipitation of the sequestered CO₂ as a solid carbonate mineral, and/or by increasing the dissolution (hydration) of gaseous CO₂ into the water and/or seawater reacting with the metal silicate. Treatment of the metal silicates with moisture (i.e., wetting with water such as fresh or salt water) may also increase the capacity and/or reactivity of metal silicates to sequester CO₂ by increasing the kinetics and magnitude of the reaction between the metal silicates, water, atmosphere, and CO₂ by similar mechanisms, and by increasing the surface area of the metal silicate that is wetted and thus available for the chemical reaction with CO₂ and the associated mobilization, transfer, and bonding of free ions, and/or by increasing the free energy of the participating materials and surfaces.

As described above, the method 10 includes allowing a change in physical or chemical property of the metal silicate over a period of time, at 18. For example, disposing or spreading the metal silicate in the path of the pre-occurring or co-occurring force such as any of those previously described herein, may cause a change in a physical parameter of the metal silicate via crushing, breaking, grinding, turning, abrading, or otherwise reduction in size of the metal silicate over a period of time. The change in physical parameter may increase the surface area of the metal silicate, which may increase carbon capture rate of the metal silicate (and/or a degree of reactivity of the metal silicate, which in turn, may increase carbon capture rate, ability, potential, and/or capacity). Additionally, or alternatively, exposure to heat, accelerants, moisture, chemicals, etc., may cause a change in chemical properties of the metal silicate that may also increase carbon capture rate of the metal silicate.

In some embodiments, the method 10 may optionally include quantifying the amount of CO₂ captured by the metal silicate, at 20. For example, the amount of CO₂ sequestered by the placement of metal silicates in the pathways of pre-occurring and/or co-occurring forces, activities, objects, and chemicals that will spread, grind, pulverize, turn, abrade, heat, and/or chemically react with the metal silicates may be estimated from the difference between concentration of dissolved inorganic carbon (“DIC”) normalized to CO₂ equivalency of natural waters that are entering the region where the metal silicates have been distributed and the concentration of DIC (normalized to CO₂ equivalency) of natural waters that are exiting the region where the metal silicates have been distributed multiplied by the volume of water flowing through that system over a given unit of time plus the total mass of the distributed metal silicates, multiplied by the mass fraction of precipitated carbonate mineral (in a sample), and divided by the mass fraction of metal silicates (in a sample and normalized to CO₂ equivalency). The mass fraction of precipitated carbonate mineral versus the mass fraction of metal silicates within a sample can be determined by conventional loss-on-ignition and/or loss-on-acidification techniques. For example, in some instances, the following equation may be used to determine the amount of sequestered CO₂:

$${CO}_{2} sequestered = ( DIC of incoming water - DIC of outgoing water ) \times ( 44 / 12 ) \times volume of water passing through system + ( mass fraction of precipitated carnbonate mineral / mass fraction of metal silicate ) \times mass of disturbed metal silicates \times ( 44 / molecular weight of carbonate mineral )$$

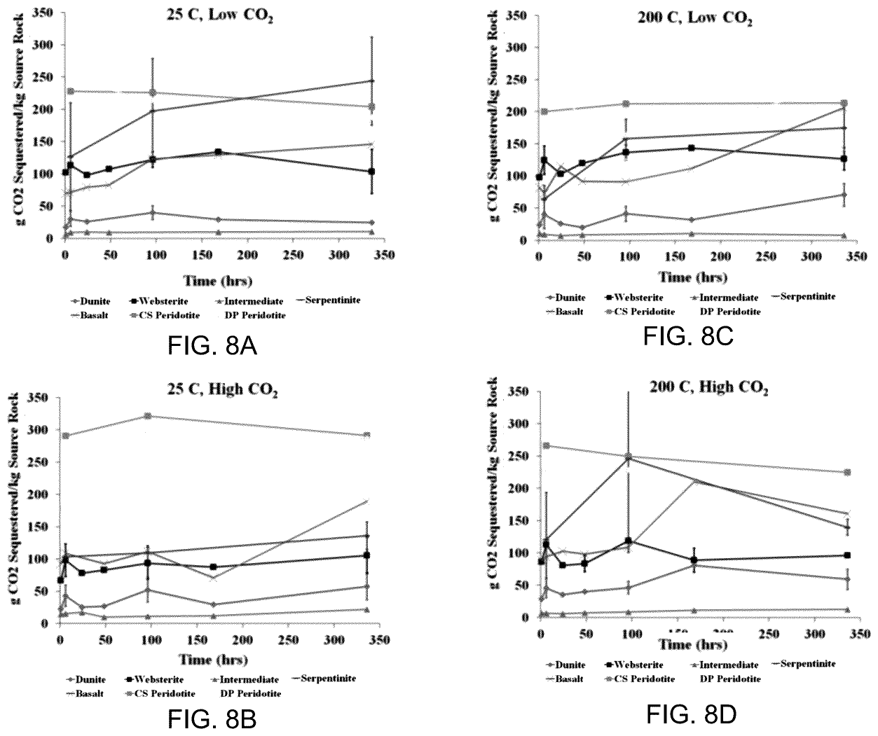

In general, the CO₂ that is stored as the dissolved inorganic carbon species (CO_{2aq}+CO₃²⁻+HCO₃⁻) is relatively stable as the water mass is transported through the river and/or groundwater systems and into the ocean because those increased concentrations of dissolved carbon species are driven by an increase in total alkalinity arising from the dissolution of the metal silicates. The CO₂ that is stored as precipitated carbonate mineral shall also be relatively stable as it is sequestered in a solid carbonate mineral. Any protons that are generated through the precipitation of the carbonate mineral phases that could potentially liberate CO₂ back to the atmosphere would be accounted for in the measurement of the net change in DIC between the incoming and outgoing waters. These field-based verifications can be augmented and/or replaced by laboratory-based experiments that replicate the reactions occurring in the field-based applications, such as those shown in FIGS. 8A-8D, 9A-9D, 10A-10D, 11A-11D, and 12A-12D.

In some embodiments, the method 10 optionally includes selling a carbon offset credit (“carbon credit”) corresponding to the amount of CO₂ captured by the metal silicates, at 22. In some embodiments, a value associated with the carbon credits sold can be related (directly or indirectly) to the amount of CO₂ captured by the metal silicates. For example, the value of carbon credits sold can be proportionally related to the amount of CO₂ captured by the metal silicates.

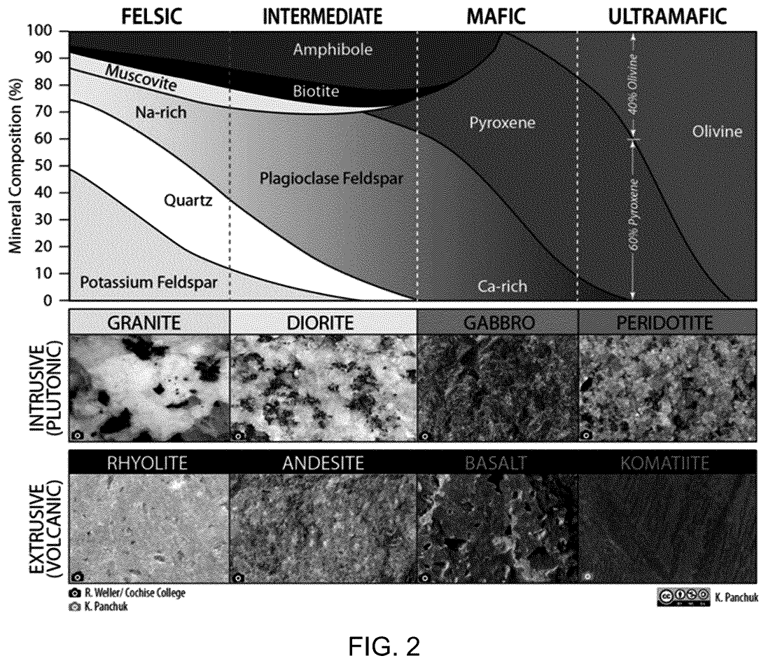

Embodiments described herein provide numerous advantages over conventional methods for sequestering carbon using metal silicates. For context, metal silicate minerals (e.g., olivine) which comprise igneous rock types, including those classified as felsic (e.g., granite, rhyolite), intermediate (e.g., diorite, andesite), mafic (e.g., gabbro, basalt), and ultramafic (e.g., peridotite, komatiite), react with water and seawater to generate alkalinity and sequester carbon dioxide (CO₂) in the form of aqueous bicarbonate ion (HCO₃⁺) and carbonate ion (CO₃²⁻) and solid carbonate minerals (e.g., CaCO₃, MgCO₃, CaMgCO₃, FeCO₃, etc.). For example, FIG. 2 is a classification diagram for igneous rocks illustrating a classification scheme for metal-silicate-bearing igneous rocks, showing increasing concentration of olivine and, thus, increasing CO₂ sequestration potential from left to right. A given rock type (depicted below the classification diagram) is represented by a corresponding vertical line in the diagram. The colored disclosure of FIG. 2 is provided in K. Panchuk, Physical Geology, First University of Saskatchewan Edition, the disclosure of which is incorporated herein by reference in its entirety.

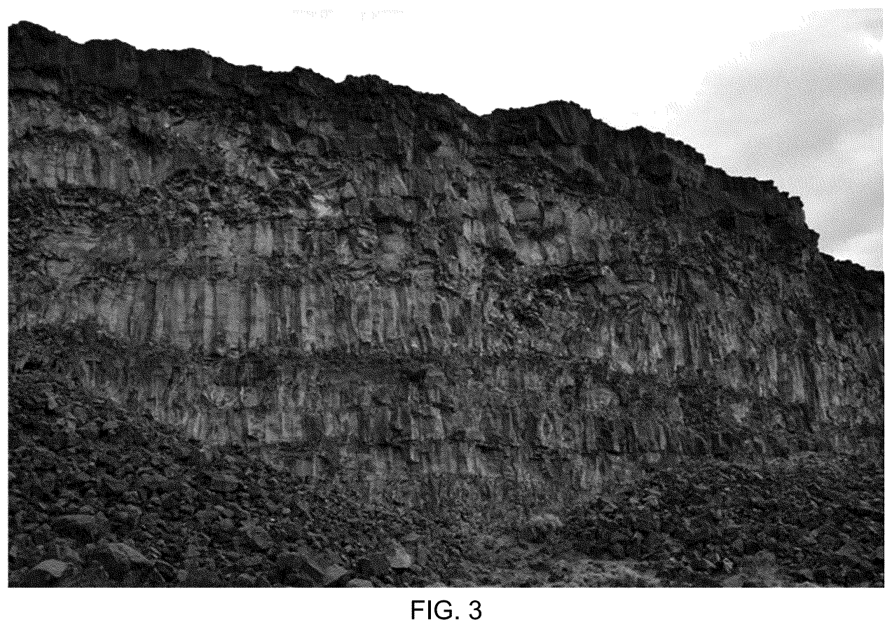

Although chemical weathering of metal silicates is one of the pathways by which CO₂ is sequestered from the Earth's fast carbon cycle in the atmosphere and upper ocean to the slower carbon cycle in the deep ocean, marine sediments, and marine limestones over geological timescales, the relatively slow rate of these chemical reactions poses challenges for the industrial adaptation of these reactions that would enable the process to sequester CO₂ at a scale that could stabilize and/or reduce atmospheric CO₂ and the associated environmental and societal impacts. For example, FIG. 3 is a photographic image of an outcropping of Snake River flood basalts in Melba, Idaho. Light coloration on surface of the outcropping is CO₂ sequestered as carbonate minerals through reactions such as those described herein. However, the extent of carbonation is limited by the small reactive surface area of the basalt due to it still being incorporated into the bedrock.

FIG. 4 is a photographic image of boulders eroded out of Snake River flood basalts in Melba, Idaho. White coloration on surface of the outcropping is CO₂ sequestered as carbonate minerals through reactions such as those described herein. The amount of carbonation is higher for basalt boulders that have eroded out of the bedrock (versus basalt that is still part of the bedrock) because of the resulting increase in reactive surface area relative to rock volume. A similar increase in reactive surface area and CO₂ sequestration potential is achieved by placing grains of metal silicates in the path of pre-occurring and/or co-occurring forces, activities, objects, and chemicals that will spread, grind, pulverize, turn, abrade, heat, and/or chemically react with the metal silicate grains, as described above. The primary way that these reactions have been accelerated in the CO₂ sequestration industry is by grinding and/or pulverizing the metal silicates to increase their reactive surface areas relative to their volumes (e.g., their surface-area-to-volume ratios). However, the hardness and density of metal silicates makes this process expensive, both from an energetic standpoint and from a CO₂ emissions standpoint, which reduces the value of the sequestered CO₂, as described above. This typically causes the cost of sequestering CO₂ by reaction with metal silicates to exceed the value of the CO₂ credit that is generated from that reaction, rendering it economically unviable.

Alternative approaches to CO₂ sequestration via weathering of metal silicates have avoided these high costs of grinding/pulverizing the metal silicates by injecting CO₂ streams directly into bedrock that is composed of these metal silicates. In these applications, the slow reaction kinetics between the metal silicates and the non-pulverized metal silicates are overcome by the many years that the existing groundwater has been reacting with the metal silicate bedrock and generating the alkalinity and divalent cations required to sequester the introduced CO₂. Thus, the CO₂ is converted to a solid carbonate mineral (e.g., CaCO₃, MgCO₃, FeCO₃) after the pure CO₂ streams are injected into the metal silicate bedrock and associated alkaline and high-TDS groundwater.

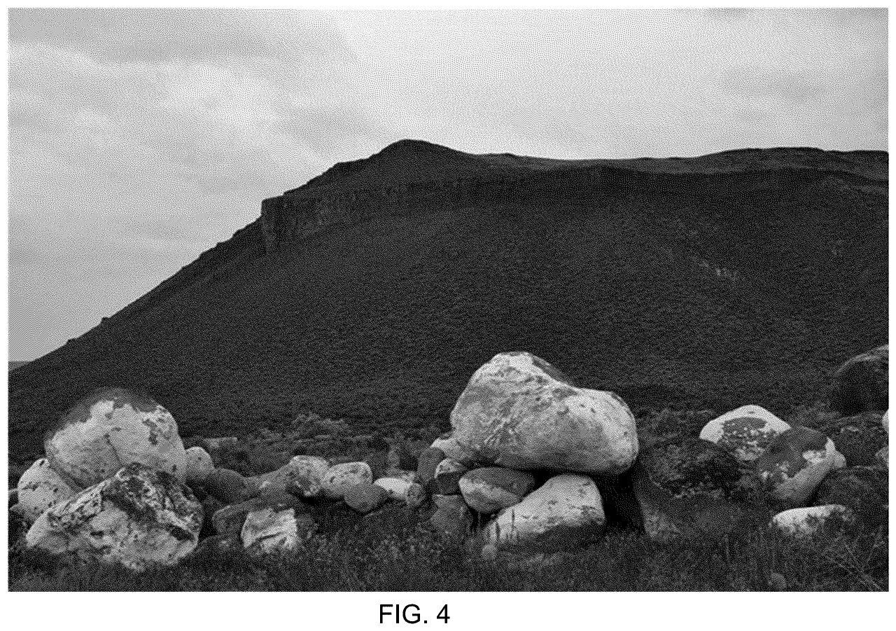

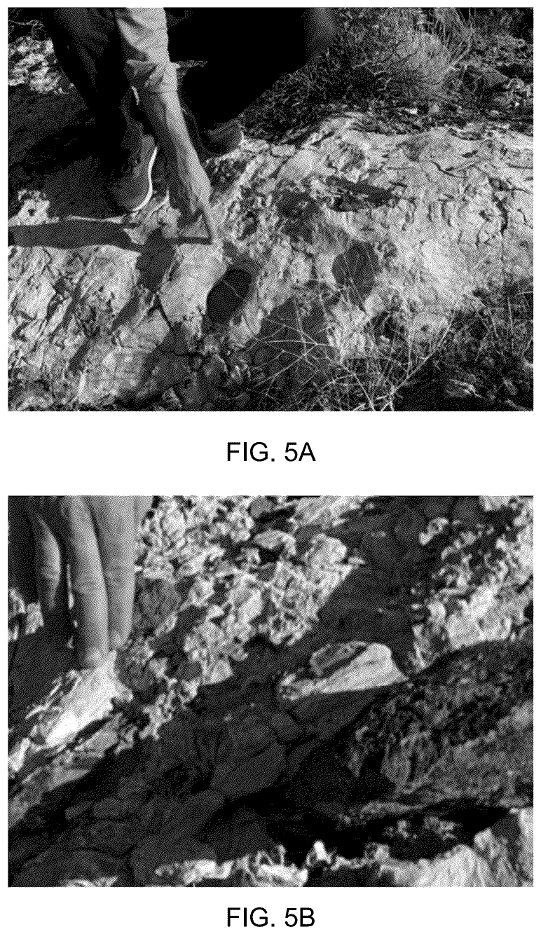

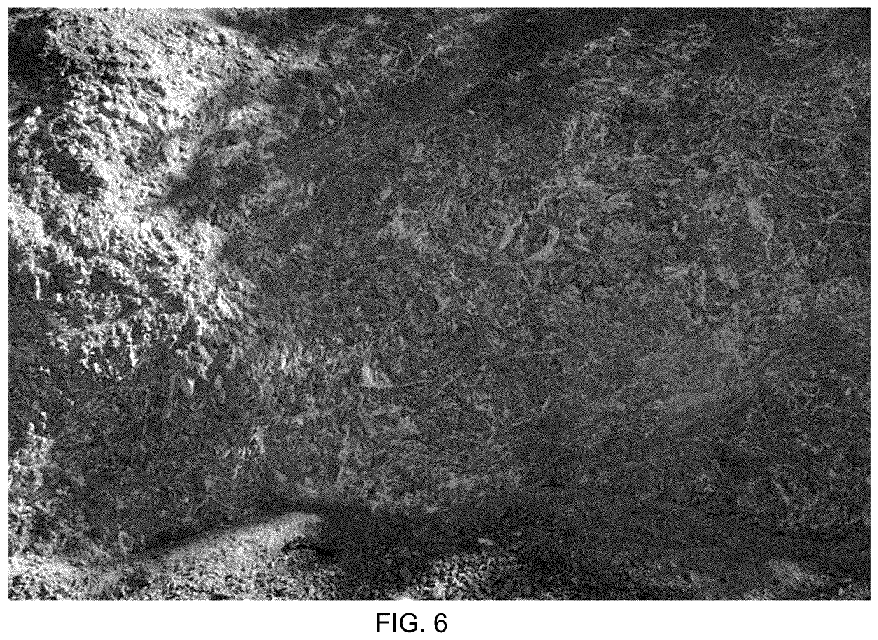

For example, FIGS. 5A and 5B are photographic images showing the site that atmospheric CO₂ is captured by seasonal spring water issuing from basalt bedrock in the Salt River floodplain (northeastern Scottsdale, Arizona). The high alkalinity and high concentration of Mg²⁺ and Ca²⁺ ions of the spring water, which were generated by reaction with the basalt bedrock in the subsurface via reactions such as those described herein, absorbs large amounts of CO₂, which then reacts with Mg²⁺ and Ca²⁺ ions in the spring water to permanently store the sequestered CO₂ as layers of the light-colored solid carbonate minerals, deposits also known as ‘travertine’ and ‘tufa’, on top of the dark colored basalt. However, when this conversion of gaseous or liquified CO₂ to a solid carbonate mineral occurs within the subsurface of the bedrock (i.e., not at the surface as shown in FIGS. 5A and 5B), it can increase the volume of the local bedrock by up to 30%, which can expand and uplift the local bedrock, causing hills to form above the injection sites, causing an increase in the frequency of local earthquakes, and causing pollution of the local groundwater-potentially creating many of the same environmental, geological, and public health hazards that are associated with hydraulic fracturing (i.e., ‘fracking’). For example, FIG. 6 is a photographic image showing how sequestration of CO₂ within metal silicate bedrock causes precipitation of carbonate minerals that can increase the volume of the local bedrock by up to 30%. This can expand and uplift the bedrock, causing hills to form above the injection sites, an increase in the frequency of local earthquakes, and pollution of the local groundwater-creating environmental, geological, and public health hazards (e.g., hammer is about 0.3 m scale). While FIGS. 3, 4, 5A, 5B, 6, and 7 are photographic images of specific locations, it should be understood that they are presented by way of example only and not limitation. It will be readily apparent that similar processes occur and/or that similar geological formations are present in other location(s) that are, for example, geologically and/or environmentally similar to those shown in FIGS. 3, 4, 5A, 5B, 6, and 7.

Embodiments described herein reduce both the high costs (in terms of both energy and emitted CO₂) associated with the grinding/pulverizing of metal silicates needed to increase reaction rates for industrially scalable CO₂ sequestration, as well as the environmental, geological, and public health hazards associated with subsurface injection of CO₂ into metal silicate bedrock systems, by placing minimally processed metal silicates in the path of pre-occurring and/or co-occurring activities, forces, objects, and/or chemicals that spread, grind, pulverize, turn, abrade, heat, and/or chemically react with these metal silicates.

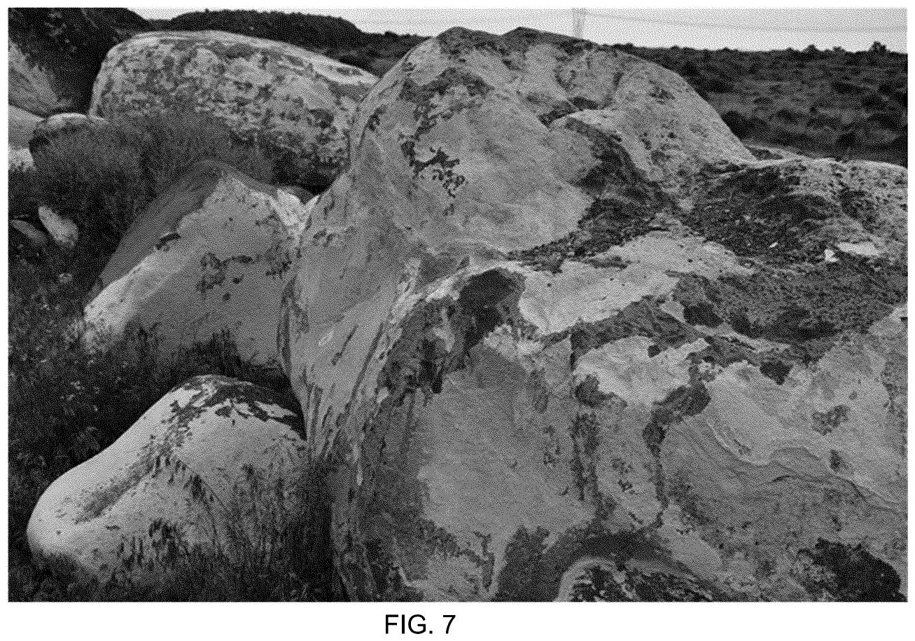

This method of distributing and allowing or providing (e.g., passively) for the processing of metal silicates will increase their reactive surface area and/or surface free energy, thereby increasing their rate of and capacity for sequestering CO₂ with minimal energetic costs and associated CO₂ emissions beyond those of the distribution process. For example, FIG. 7 is a photographic image of boulders eroded out of Snake River flood basalts in Melba, Idaho, showing how mechanical action, such as, for example, from vehicle traffic, plowing, grading, glaciers, waves, and currents, can abrade precipitated CaCO₃ (white surface) from the surface of metal silicates, thereby re-exposing and reactivating the original surface and/or fresh unreacted surface (gray surface) of the metal silicate grains for additional CO₂ sequestration.

Embodiments and/or methods described herein provide several advantages over conventional carbon sequestration methods. For example, the methods described herein increase reaction rates and total CO₂ sequestered by increasing reactive surface area of the metal silicates by: (1) spreading or disposing a thin layer of the metal silicates over broad areas in order to increase the proportion of their surface area that is in direct contact with atmospheric CO₂; (2) grinding and pulverizing the metal silicates; (3) agitating and turning the metal silicates; (4) abrading precipitated CaCO₃ (derived from the sequestered CO₂) off of the surfaces of the metal silicates, thereby re-exposing their reactive surfaces to atmospheric CO₂, and/or via any other suitable process. Embodiments and/or methods described herein may increase reaction rates and total CO₂ sequestered by: (1) heating the metal silicates through mechanical friction and/or exhaust heat; (2) increasing reactive surface area of the metal silicates by agitating and turning the metal silicate, and/or by increasing the partial pressure of CO₂ (pCO₂) in the local atmosphere reacting with the metal silicates by way of vehicle exhaust and/or other existing sources of CO₂; (3) reacting the metal silicates with chemicals that are already deployed and/or are being deployed to increase traction on the traveled surfaces, such as road salts (e.g., MgCl₂, CaCl₂, NaCl, (Mg,Ca)Cl₂) or other alkaline or acidic chemicals, that may accelerate the dissolution of the metal silicates and/or mineralization of the sequestered CO₂ as carbonate minerals; and/or (4) increasing the capacity and/or rate of metal silicates to sequester atmospheric CO₂ by placing them in the path of pre-occurring or preexisting forces that will spread, grind, pulverize, turn, abrade, heat, and chemically react with the metal silicates, and which is less expensive than using dedicated (non-preexisting) processes that require additional energy to perform these functions (e.g., dedicated rock crushers, grinders, furnaces, chemical accelerants, etc.)

Embodiments of the methods described herein are further advantageous because less CO₂ is emitted by using pre-occurring processes to increase the capacity and/or rate of metal silicates to sequester atmospheric CO₂ by spreading, grinding, pulverizing, turning, abrading, heating, and chemically reacting with the metal silicates, than by using non-pre-occurring, dedicated processes to perform these functions. Moreover, using the methods described herein results in the distribution of metal silicates, as well as the generation of solid byproducts of the weathering reactions (e.g., clays, carbonate minerals, etc.), that may increase vehicular and human traction on traveled surfaces, especially when the traveled surfaces are subject to ice, snow, rain, and other conditions that decrease the friction of the traveled surface. Methods described herein may also generate additional byproducts of the weathering reactions (e.g., silicic acid, clays, carbonate minerals, etc.) that may increase the stability of the sensitive and/or unstable natural system (e.g., riverbeds, periglacial environments, active margins of lakes and oceans, etc.) by, for example, cementing together the sediments in those systems and reducing the effects of erosion and/or sea level rise.

FIGS. 8A-8D, 9A-9D, 10A-10D, 11A-11D, and 12A-12D show various graphs showing a relationship between carbon sequestration and various properties of metal silicates. For example, FIGS. 8A-8D are graphs illustrating total amounts of CO₂ sequestered vs. time for seven (7) types of metal silicates that were reacted in controlled laboratory experiments at 25 degrees Celsius (FIG. 8A and FIG. 8B) and 200 degrees Celsius (FIG. 8C and FIG. 8D) and at low pCO₂ (FIG. 8A and FIG. 8C) and high pCO₂ (FIG. 8B and FIG. 8D) conditions. The graphs shown in FIG. 8 illustrate how the amount of CO₂ sequestered varies systematically with the type of metal silicates involved in the reaction, with the lower olivine metal silicates classified as intermediate igneous composition sequestering the least CO₂, the higher olivine basalt metal silicates classified as mafic igneous composition sequestering intermediate amounts of CO₂, and the highest-olivine containing peridotite metal silicates classified as ultramafic igneous composition sequestering the highest amounts of CO₂.

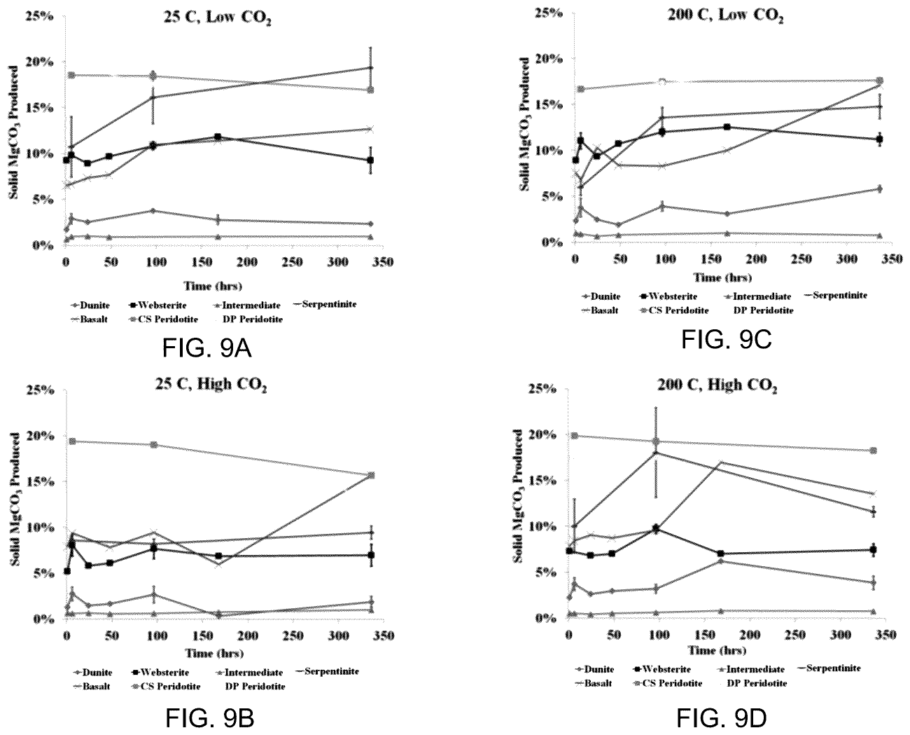

FIGS. 9A-9D are graphs illustrating amounts of solid MgCO₃ produced (i.e., atmospheric CO₂ stored as solid carbonate mineral) vs. time for seven (7) types of metal silicates that were reacted in controlled laboratory experiments at 25 degrees Celsius (FIG. 9A and FIG. 9B) and 200 degrees Celsius (FIG. 9C and FIG. 9D) and at low pCO₂ (FIG. 9A and FIG. 9C) and high pCO₂ (FIG. 9B and FIG. 9D) conditions. The graphs show that the amount of MgCO₃ produced varies systematically with the type of metal silicates involved in the reaction, with the lower olivine metal silicates classified as intermediate igneous composition producing the least solid MgCO₃, the higher olivine basalt metal silicates classified as mafic igneous composition producing intermediate amounts of solid MgCO₃, and the highest-olivine containing peridotite metal silicates classified as ultramafic igneous composition producing the most solid MgCO₃.

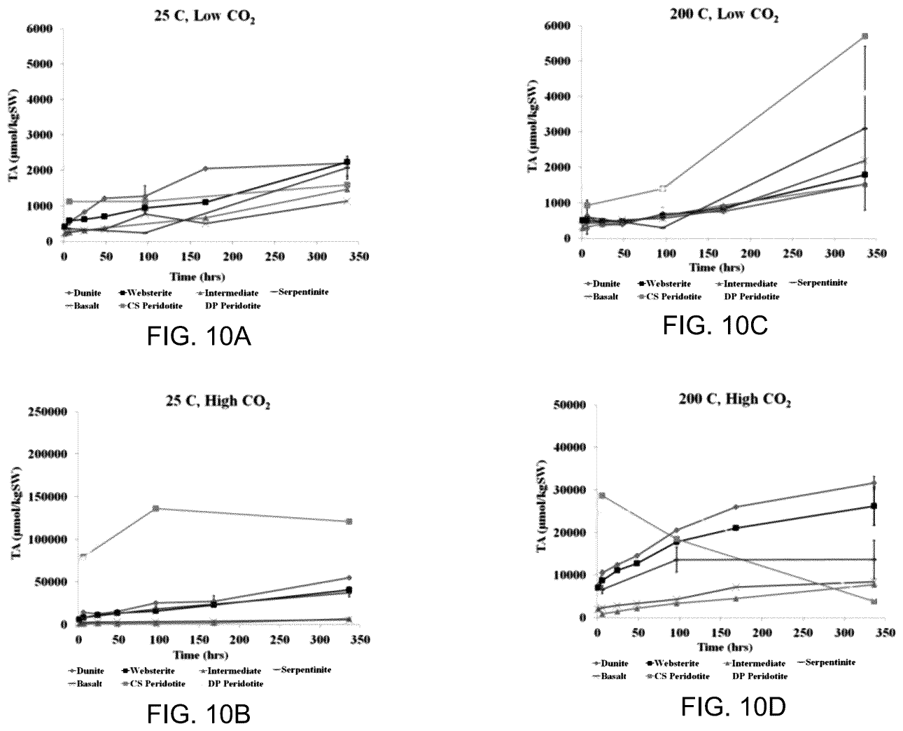

FIGS. 10A-10D are graphs illustrating total alkalinity of water (e.g., a driving mechanism for the transfer of atmospheric CO₂ into the water) vs. time for seven (7) types of metal silicates that were reacted in controlled laboratory experiments at 25 degrees Celsius (FIG. 10A and FIG. 10B) and 200 degrees Celsius (FIG. 10C and FIG. 10D) and at low pCO₂ (FIG. 10A and FIG. 10C) and high pCO₂ (FIG. 10B and FIG. 10D) conditions. The graphs show that the amount of alkalinity produced varies systematically with the type of metal silicates involved in the reaction, with the lower olivine metal silicates classified as intermediate igneous composition producing the least alkalinity, the higher olivine basalt metal silicates classified as mafic igneous composition producing intermediate amounts of alkalinity, and the highest-olivine containing peridotite metal silicates classified as ultramafic igneous composition producing the most alkalinity.

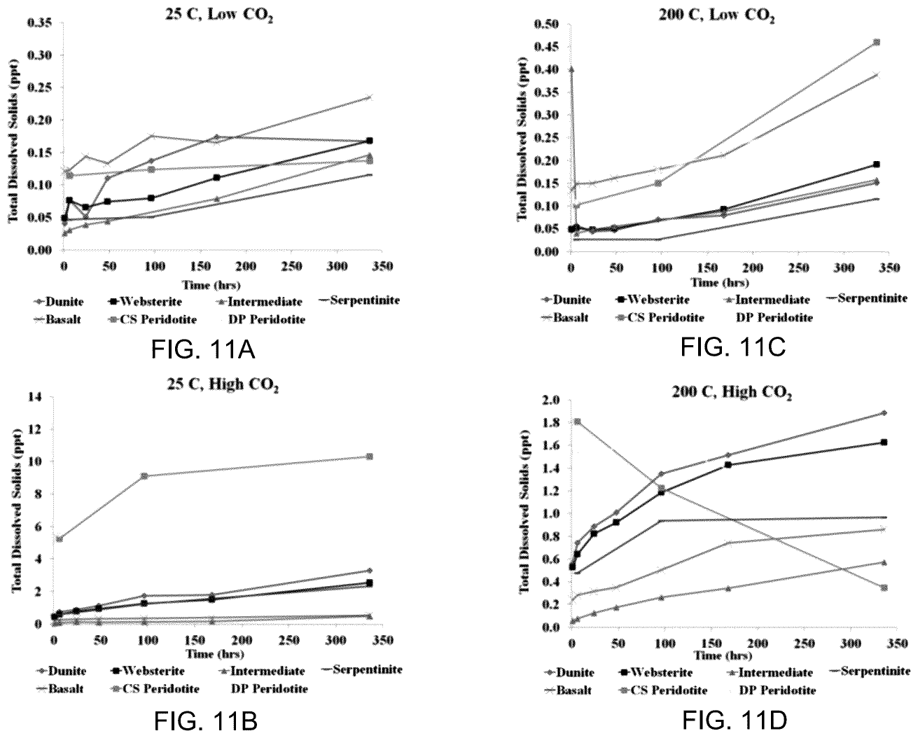

FIGS. 11A-11D are graphs illustrating amounts of total dissolved solids in water (including the critical divalent cations Mg²⁺ and Ca²⁺ that react with the sequestered CO₂ in the form of CO₃²⁻ and HCO₃⁻ to form solid carbonate minerals) vs. time for seven (7) types of metal silicates that were reacted in controlled laboratory experiments at 25 degrees Celsius (FIG. 11A and FIG. 11B) and 200 degrees Celsius (FIG. 11C and FIG. 11D) and at low pCO₂ (FIG. 11A and FIG. 11C) and high pCO₂ (FIG. 11B and FIG. 11D) conditions. The graphs show that the amount of total dissolved solids produced varies systematically with the type of metal silicates involved in the reaction, with the lower olivine metal silicates classified as intermediate igneous composition producing the least total dissolved solids, the higher olivine basalt metal silicates classified as mafic igneous composition producing intermediate amounts of total dissolved solids, and the highest-olivine containing peridotite metal silicates classified as ultramafic igneous composition producing the most total dissolved solids.

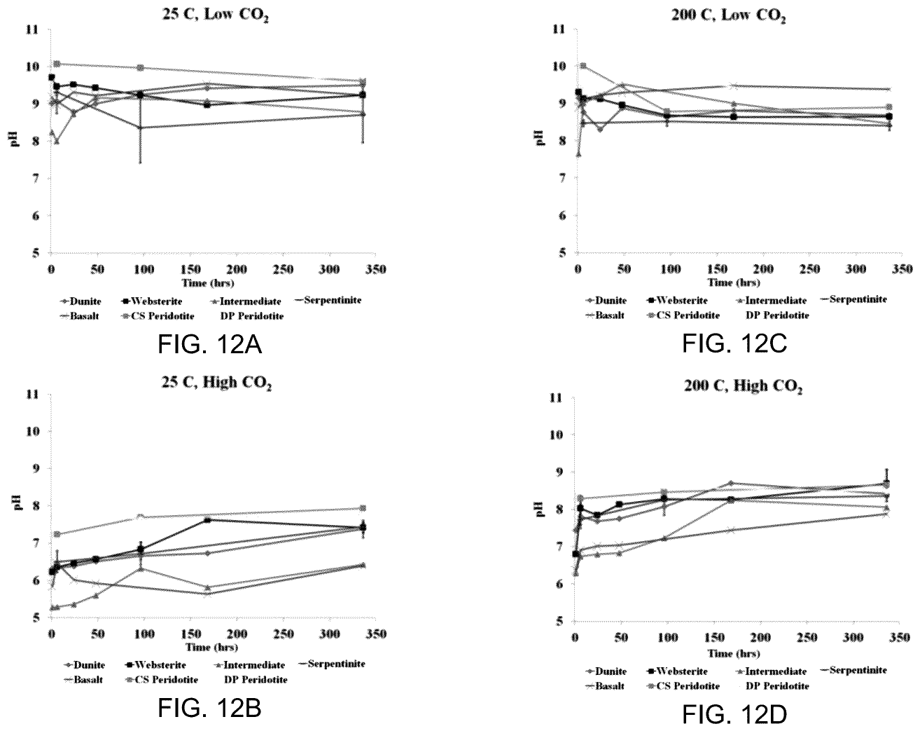

FIGS. 12A-12D are graphs illustrating a pH of water (e.g., indicating a receptivity of water for sequestering atmospheric CO₂) vs. time for seven (7) types of metal silicates that were reacted in controlled laboratory experiments at 25 degrees Celsius (FIGS. 12A and 12B) and 200 degrees Celsius (FIG. 12C and FIG. 12D) and at low pCO₂ (FIG. 12A and FIG. 12C) and high pCO₂ (FIG. 12B and FIG. 12D) conditions. The graphs show that the pH varies systematically with the type of metal silicates involved in the reaction, with the lower olivine metal silicates classified as intermediate igneous composition producing the lowest water pH, the higher olivine basalt metal silicates classified as mafic igneous composition producing intermediate water pH, and the highest-olivine containing peridotite metal silicates classified as ultramafic igneous composition producing the highest water pH.

Results of such experiments (e.g., leading to the data presented in the graphs shown in FIGS. 8A-8D, 9A-9D, 10A-10D, 11A-11D, and 12A-12D) show the capacity of different types of metal silicates for sequestering atmospheric pCO₂ and could augment and/or replace field-based verification of the CO₂ sequestered by the distribution of metal silicates in the path of pre-occurring and/or co-occurring forces, activities, objects, and chemicals that will increase the rates and magnitudes of CO₂ sequestration reactions as described herein.

It is important to note that the construction and arrangement of the various embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the any of the teachings and/or advantages of the subject matter described herein. Other substitutions, modifications, changes, and/or omissions may also be made in the design, operating conditions, and/or arrangement of the various embodiments without departing from the scope of the disclosure. Where schematics and/or embodiments described above indicate certain components arranged in certain orientations or positions, the arrangement of components may be modified.

While this specification contains many specific implementation details, these should not be construed as limitations on the scope of any embodiments or use of embodiments, or of what may be claimed, but rather as descriptions of features or aspects specific to particular implementations. Certain features and/or aspects described in this specification in the context of separate implementations can also be implemented in combination in a single implementation. Conversely, various features and/or aspects described in the context of a single implementation can also be implemented in multiple implementations separately or in any suitable subcombination(s). Moreover, although features may be described above as acting in certain combinations and even initially claimed as such, one or more features from a combination can in some cases be excised from the combination to define and/or form a subcombination(s) or variation of a subcombination(s) thereof.

Thus, while particular implementations have been described, other implementations are within the scope of the disclosure and the appended claims. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
placing a metal silicate mineral (metal silicates) in a path of a pre-occurring or co-occurring force, the metal silicates having a first carbon capture rate; and
allowing a change in at least one of a physical property or a chemical property of the metal silicates over a period of time as a result of the pre-occurring or co-occurring force such that the metal silicates have a second carbon capture rate greater than the first carbon capture rate.

2. The method of claim 1, wherein the pre-occurring or co-occurring force is mechanical action.

3. The method of claim 1, wherein the change in at least one of a physical property or chemical property is an increase in at least one of a surface area or a temperature.

4. The method of claim 1, wherein the allowing the change in at least one of the physical property or the chemical property includes:
reacting the metal silicates with a chemical that accelerates at least one of dissolution of the metal silicates or mineralization of carbon dioxide.

5. The method of claim 4, wherein the chemical includes at least one of road salt, an alkaline chemical, or an acidic chemical.

6. The method of claim 1, further comprising:
at least one of pretreating the metal silicates before exposing the metal silicates to the pre-occurring or co-occurring force, or post-treating the metal silicates after exposing the metal silicates to the pre-occurring or co-occurring force.

7. The method of claim 1, further comprising:
quantifying an amount of CO₂ captured by the metal silicate.

8. The method of claim 7, further comprising:
selling a carbon credit corresponding to the amount of CO₂ captured by the metal silicate.

9. The method of claim 1, further comprising:
selecting the metal silicates from at least one of an intermediate igneous composition, mafic igneous composition, or an ultramafic igneous composition.

10. A method, comprising:
placing a metal silicate mineral (metal silicates) in a path of a pre-occurring or co-occurring force, the metal silicates having a first carbon capture rate; and
allowing a change of a particle size of the metal silicates over a period of time as a result of the pre-occurring or co-occurring force such that the metal silicates have a second carbon capture rate greater than the first carbon capture rate.

11. The method of claim 10, wherein the change of the particle size of the metal silicates includes reducing the particle size of the metal silicates to about 100 microns to about 300 microns.

12. The method of claim 10, wherein the pre-occurring or co-occurring force is at least one of crushing, breaking, grinding, turning, or abrading.

13. The method of claim 10, further comprising:
selecting the metal silicates from at least one of an intermediate igneous composition, mafic igneous composition, or an ultramafic igneous composition.

14. The method of claim 10, further comprising:
quantifying an amount of CO₂ captured by the metal silicate.

15. The method of claim 14, further comprising:
selling a carbon credit corresponding to the amount of CO₂ captured by the metal silicate.

16. A method, comprising:
placing a metal silicate mineral (metal silicates) in a path of a pre-occurring or co-occurring force, the metal silicates having a first reactivity associated with carbon capture, the pre-occurring or co-occurring force operable to change at least one of a physical property or a chemical property of the metal silicate; and
allowing a change in the metal silicates over a period of time as a result of the pre-occurring or co-occurring force such that the metal silicates have a second reactivity associated with carbon capture greater than the first reactivity.

17. The method of claim 16, wherein the pre-occurring or co-occurring force exposes the metal silicates to friction, heat, accelerants, moisture, or chemicals.

18. The method of claim 16, further comprising:
at least one of pretreating the metal silicates before exposing the metal silicates to the pre-occurring or co-occurring force, or post-treating the metal silicates after exposing the metal silicates to the pre-occurring or co-occurring force.

19. The method of claim 16, further comprising:
quantifying an amount of CO₂ captured by the metal silicate.

20. The method of claim 19, further comprising:
selling a carbon credit corresponding to the amount of CO₂ captured by the metal silicate.
